(19) United States
(12) Patent Application Publication
(10) Pub. No.: US 2013/0123417 A1
(43) Pub. Date: May 16, 2013

(54) PRESSURE-SENSITIVE ADHESIVE SHEET

(71) Applicant: NITTO DENKO CORPORATION, Ibaraki-shi (JP)

(72) Inventors: Shou Takarada, Ibaraki-shi (JP); Takahiro Nonaka, Ibaraki-shi (JP)

(73) Assignee: NITTO DENKO CORPORATION, Ibaraki-shi (JP)

(21) Appl. No.: 13/673,172

(22) Filed: Nov. 9, 2012

(30) Foreign Application Priority Data
Nov. 10, 2011 (JP) 2011-246877
Apr. 13, 2012 (JP) 2012-091586

(51) Int. Cl. C09J 133/08

(52) U.S. Cl. CPC C09J 133/08
USPC 524/548; 526/264

(57) ABSTRACT

A pressure-sensitive adhesive sheet excellent in the resistance to clouding caused by humidification, and excellent in the level difference absorbability, in particular, in the level difference absorbability for a high level difference is provided. The pressure-sensitive adhesive sheet of the present invention is a pressure-sensitive adhesive sheet including a pressure-sensitive adhesive layer, wherein the pressure-sensitive adhesive layer includes an acrylic polymer obtained by polymerizing monomer components; the monomer components includes alkyl (meth)acrylate having a linear or branched alkyl group having 10 to 16 carbon atoms and a hydrophilic monomer; the content of the alkyl (meth)acrylate is 30% by weight or more in relation to the total amount (100% by weight) of the monomers; and the content of the hydrophilic monomer is 10% by weight or more in relation to the total amount (100% by weight) of the monomers.

### TECHNICAL FIELD

The present invention relates to a pressure-sensitive adhesive sheet. Specifically, the present invention relates to a pressure-sensitive adhesive sheet particularly suitably usable for laminating optical components, for production of optical products and for other applications.

### BACKGROUND ART

Recently, in various fields, display devices such as liquid crystal displays (LCDs) and input devices such as touch panels used in combination with the display devices have been widely used. In the fields including the production of these display devices and input devices, transparent pressure-sensitive adhesive sheets are used in the applications to laminating optical components. For example, for attaching a touch panel, a lens or the like to a liquid crystal display device (such as LCD), a transparent pressure-sensitive adhesive sheet is used (for example, see Patent Literature 1 to Patent Literature 3).

### CITATION LIST

### Patent Literature

Patent Literature 1: Japanese Patent Application Laid-Open No. 2003-238915

Patent Literature 2: Japanese Patent Application Laid-Open No. 2003-342542

Patent Literature 3: Japanese Patent Application Laid-Open No. 2004-231723

### SUMMARY OF INVENTION

### Technical Problem

Recently, the pressure-sensitive adhesive sheets used in the foregoing applications have been strongly demanded to have a property not to cause cloudiness (resistance to clouding caused by humidification) in high temperature-high humidity environment.

Among optical components, components involving level differences such as printing level difference are growing in number. For example, on a liquid crystal display device, a lens component undergoing a frame-shaped printing is sometimes laminated through the intermediary of a double-sided pressure-sensitive adhesive sheet. In such an application, the pressure-sensitive adhesive sheet is demanded to have a capability to compensate the level difference such as printing level difference, namely, an excellent level difference absorbability (also referred to as “level difference followability”). In particular, in a case where a rigid body and another rigid body are laminated to each other, the pressure-sensitive adhesive sheet is also demanded to have a capability to cope with a further higher level difference (for example, a level difference exceeding 40 μm in height).

It is to be noted that the resistance to clouding caused by humidification and the level difference absorbability are demanded in various applications as well as in the applications to laminating optical components.

Accordingly, an object of the present invention is to provide a pressure-sensitive adhesive sheet having an excellent resistance to clouding caused by humidification and an excellent level difference absorbability, in particular, even for a high level difference.

### Solution to Problem

The present inventors made a diligent study, and consequently have perfected the present invention by discovering that when the monomer components constituting the polymer included in the pressure-sensitive adhesive layer belonging to a pressure-sensitive adhesive sheet includes a specific amount or more of an alkyl (meth)acrylate having a linear or branched alkyl group having 10 to 16 carbon atoms, and also includes a specific amount or more of a hydrophilic monomer, it is possible to obtain a pressure-sensitive adhesive sheet that has an excellent level difference absorbability even for a high level difference, and further has an excellent resistance to clouding caused by humidification.

Specifically, the present invention provides a pressure-sensitive adhesive sheet including a pressure-sensitive adhesive layer, wherein the pressure-sensitive adhesive layer includes an acrylic polymer obtained by polymerizing monomer components, the monomer components include an alkyl (meth)acrylate having a linear or branched alkyl group having 10 to 16 carbon atoms and a hydrophilic monomer, the content of the alkyl (meth)acrylate is 30% by weight or more in relation to the total amount (100% by weight) of the monomer components, and the content of the hydrophilic monomer is 10% by weight or more in relation to the total amount (100% by weight) of the monomer components.

In the pressure-sensitive adhesive layer, the content of the acrylic polymer is preferably 50% by weight or more.

Preferably, the gel fraction of the pressure-sensitive adhesive layer is 40 to 85% by weight, and the shear storage modulus of the pressure-sensitive adhesive layer at 23° C. is 1.0×10⁵ Pa or less.

The hydrophilic monomer is preferably a monomer selected from the group consisting of a hydroxyl group-containing monomer and a heterocyclic ring-containing vinyl monomer.

The pressure-sensitive adhesive sheet has a haze of preferably 1.0% or less and a total light transmittance of preferably 90% or more.

The pressure-sensitive adhesive sheet preferably includes only the aforementioned pressure-sensitive adhesive layer.

### Advantageous Effects of Invention

The pressure-sensitive adhesive sheet of the present invention has the aforementioned constitution, and hence is excellent in the resistance to clouding caused by humidification and excellent in the level difference absorbability, in particular, even in the level difference absorbability for a high level difference. Consequently, the pressure-sensitive adhesive sheet of the present invention is particularly useful as the optical pressure-sensitive adhesive sheet to be used in laminating optical components, in the production of optical components and optical products and in other applications.

### BRIEF DESCRIPTION OF DRAWINGS

FIG. 1 is a schematic view (plan view) illustrating a glass plate with a printing level difference, used in the evaluation of the level difference absorbability.

FIG. 2 is a schematic view (a cross-sectional view along the line segment A-A′) illustrating the glass plate with a printing level difference, used in the evaluation of the level difference absorbability.

### DESCRIPTION OF EMBODIMENTS

[Pressure-Sensitive Adhesive Sheet]

The pressure-sensitive adhesive sheet of the present invention includes at least a pressure-sensitive adhesive layer including an acrylic polymer obtained by polymerizing specific monomer components. In present Description, “an acrylic polymer obtained by polymerizing specific monomer components” is sometimes referred to as “the acrylic polymer A,” and “a pressure-sensitive adhesive layer including an acrylic polymer (acrylic polymer A) obtained by polymerizing specific monomer components” is sometimes referred to as “the pressure-sensitive adhesive layer A.”

In the acrylic polymer A, the essential monomer components constituting the polymer includes the alkyl (meth)acrylate having a linear or branched alkyl group having 10 to 16 carbon atoms in a content of 30% by weight or more in relation to the total amount (100% by weight) of the monomer components, and further includes a hydrophilic monomer in a content of 10% by weight or more in relation to the total amount (100% by weight) of the monomer components.

It is to be noted that “(meth)acrylic” means “acrylic” and/or “methacrylic” (one or both of “acrylic” and “methacrylic”), and this is also the case in what follows. Additionally, “a (meth)acryloyl group” means “an acryloyl group” and/or “a methacryloyl group” (one or both of “an acryloyl group” and “a methacryloyl group”), and this is also the case in what follows.

In present Description, “an alkyl (meth)acrylate having a linear or branched alkyl group having 10 to 16 carbon atoms” is referred to as “a C₁₀₋₁₆ alkyl (meth)acrylate,” as the case may be.

Additionally, “an alkyl group” means a linear or branched alkyl group unless otherwise specified.

Additionally, “a pressure-sensitive adhesive sheet” is defined to include a meaning of “a pressure-sensitive adhesive tape.” In other words, the pressure-sensitive adhesive sheet of the present invention may be a pressure-sensitive adhesive tape having a tape-shaped form.

The pressure-sensitive adhesive sheet of the present invention may be a single-sided pressure-sensitive adhesive sheet only one side of which is a pressure-sensitive adhesive layer surface (pressure-sensitive adhesive surface, namely, the pressure-sensitive adhesive layer A surface), or a double-sided pressure-sensitive adhesive sheet both sides of which are pressure-sensitive adhesive layer surfaces. The pressure-sensitive adhesive sheet of the present invention is not particularly limited, but is preferably a double-sided pressure-sensitive adhesive sheet, and more preferably a double-sided pressure-sensitive adhesive sheet both sides of which are the pressure-sensitive adhesive layer A surfaces, from the viewpoint that the pressure-sensitive adhesive sheet is used for the purpose of laminating adherends to each other and other like purposes.

The pressure-sensitive adhesive sheet of the present invention may be a pressure-sensitive adhesive sheet having no substrate (no substrate layer), namely, a so-called “substrate-less type” pressure-sensitive adhesive sheet (also sometimes referred to as “a substrate-less pressure-sensitive adhesive sheet”), or a pressure-sensitive adhesive sheet having a substrate (also sometimes referred to as “a substrate-including pressure-sensitive adhesive sheet”). Examples of the substrate-less pressure-sensitive adhesive sheet include: a double-sided pressure-sensitive adhesive sheet composed only of the pressure-sensitive adhesive layer A; and a double-sided pressure-sensitive adhesive sheet composed of the pressure-sensitive adhesive layer A and a pressure-sensitive adhesive layer (sometimes referred to as “the other pressure-sensitive adhesive agent layer”) other than the pressure-sensitive adhesive layer A. Examples of the pressure-sensitive adhesive sheet having a substrate include: a single-sided pressure-sensitive adhesive sheet having the pressure-sensitive adhesive layer A on one side of a substrate; a double-sided pressure-sensitive adhesive sheet having the pressure-sensitive adhesive layer A on each of both sides of a substrate; and a double-sided pressure-sensitive adhesive sheet having the pressure-sensitive adhesive layer A on one side of a substrate and the other pressure-sensitive adhesive layer on the other side of the substrate.

Among the aforementioned pressure-sensitive adhesive sheets, from the viewpoint of improving the optical properties such as transparency, the substrate-less pressure-sensitive adhesive sheet is preferable, and the double-sided pressure-sensitive adhesive sheet (substrate-less double-sided pressure-sensitive adhesive sheet) being composed only of the pressure-sensitive adhesive layers A and having no substrate is more preferable. When the pressure-sensitive adhesive sheet of the present invention is a pressure-sensitive adhesive sheet having a substrate, the pressure-sensitive adhesive sheet is not particularly limited, but from the viewpoint of workability, is preferably a double-sided pressure-sensitive adhesive sheet (a substrate-including double-sided pressure-sensitive adhesive sheet) having the pressure-sensitive adhesive layer A on each of both sides of a substrate.

The aforementioned “substrate (substrate layer)” is the part to be attached to an adherend together with the pressure-sensitive adhesive layer, when the pressure-sensitive adhesive sheet of the present invention is applied (attached) to the adherend (such as an optical component); the aforementioned “substrate (substrate layer)” does not include a release film (separator) to be released when the pressure-sensitive adhesive sheet is used (attached).

(Pressure-Sensitive Adhesive Layer A)

The pressure-sensitive adhesive layer A includes at least the acrylic polymer A. The acrylic polymer A is a polymer obtained by polymerizing monomer components, and is a polymer in which the monomer components include at least a C₁₀₋₁₆ alkyl (meth)acrylate and a hydrophilic monomer, the content of the C₁₀₋₁₆ alkyl (meth)acrylate is 30% by weight or more in relation to the total amount (100% by weight) of the monomer components, and the content of the hydrophilic monomer is 10% by weight or more in relation to the total amount (100% by weight) of the monomer components. The polymer(s) included in the pressure-sensitive adhesive layer A may be only the acrylic polymer A, or the acrylic polymer A and a polymer(s) other than the acrylic polymer A.

With respect to the acrylic polymer A, the monomer components preferably include a monomer (an acrylic monomer) having a (meth)acryloyl group in the molecule thereof in a content of 30% by weight or more (more preferably 40% by weight or more and more preferably 80% by weight or more) in relation to the total amount (100% by weight) of the monomer components.

The content of the acrylic polymer A in the pressure-sensitive adhesive layer A is not particularly limited, but is 50% by weight or more, more preferably 60% by weight or more and furthermore preferably 80% by weight or more, in relation to the total amount (total weight, 100% by weight) of the pressure-sensitive adhesive layer A, for the purpose of obtaining excellent level difference absorbability and excellent resistance to clouding caused by humidification while the adhesion reliability is being obtained.

The pressure-sensitive adhesive layer A is formed of a pressure-sensitive adhesive composition. The pressure-sensitive adhesive composition may be a pressure-sensitive adhesive composition having any form; examples of the form of the pressure-sensitive adhesive composition include an emulsion type, a solvent type (a solution type), an active energy ray curable type and a heat melt type (a hot melt type). Examples of the preferable pressure-sensitive adhesive composition among these above-listed pressure-sensitive adhesive compositions include a solvent-type pressure-sensitive adhesive composition and an active energy ray curable-type pressure-sensitive adhesive composition. In present Description, the pressure-sensitive adhesive composition forming the pressure-sensitive adhesive layer A is sometimes referred to as the pressure-sensitive adhesive composition A.

Examples of the solvent-type pressure-sensitive adhesive composition preferably include a pressure-sensitive adhesive composition A including the acrylic polymer A as an essential component. Examples of the active energy ray curable-type pressure-sensitive adhesive composition preferably include a mixture of the monomer components (monomer mixture) constituting the acrylic polymer A, or the pressure-sensitive adhesive composition A including as an essential component a partially polymerized substance of the mixture. The partially polymerized substance as referred to herein means a composition in which one or two or more components of the monomer components included in the monomer mixture are partially polymerized.

In particular, from the viewpoints of productivity, effect on the environment and easiness in obtaining a pressure-sensitive adhesive layer having a certain thickness, the pressure-sensitive adhesive composition A is preferably an active energy ray curable-type pressure-sensitive adhesive composition including, as an essential component, a mixture (monomer mixture) of the monomer components constituting the acrylic polymer A or a partially polymerized substance of the mixture.

The pressure-sensitive adhesive constituting the pressure-sensitive adhesive layer A is not particularly limited as long as the pressure-sensitive adhesive layer A includes the acrylic polymer A; however, the pressure-sensitive adhesive constituting the pressure-sensitive adhesive layer A is preferably an acrylic pressure-sensitive adhesive.

With respect to the acrylic polymer A, the monomer components include at least a C₁₀₋₁₆ alkyl (meth)acrylate. The C₁₀₋₁₆ alkyl (meth)acrylate is not particularly limited; however, examples of the C₁₀₋₁₆ alkyl (meth)acrylate include dodecyl (meth)acrylate, tridecyl (meth)acrylate, tetradecyl (meth)acrylate, pentadecyl (meth)acrylate, isopentadecyl (meth)acrylate, hexadecyl (meth)acrylate and isohexadecyl (meth)acrylate. These C₁₀₋₁₆ alkyl (meth)acrylates may be used each alone or in combinations of two or more thereof.

Among these, as the C₁₀₋₁₆ alkyl (meth)acrylate, an alkyl (meth)acrylate having a linear or branched alkyl group having 10 to 13 carbon atoms is preferable, an alkyl (meth)acrylate having a linear or branched alkyl group having 12 carbon atoms is more preferable, and lauryl acrylate is furthermore preferable.

The content of the C₁₀₋₁₆ alkyl (meth)acrylate in the monomer components constituting the acrylic polymer A is, from the viewpoint of the resistance to clouding caused by humidification and the level difference absorbability, 30% by weight or more, preferably 40% by weight or more and more preferably 50% by weight or more, in relation to the total amount (100% by weight) of the monomer components.

With respect to the acrylic polymer A, the monomer components further include a hydrophilic monomer. The hydrophilic monomer is a monomer having in the molecule thereof a hydrophilic group and an ethylenically unsaturated bond (carbon-carbon double bond). Specific examples of the hydrophilic monomer include: hydroxyalkyl (meth)acrylates such as 2-hydroxyethyl (meth)acrylate, 3-hydroxypropyl (meth)acrylate, 4-hydroxybutyl (meth)acrylate and 6-hydroxyhexyl (meth)acrylate; hydroxyl group-containing monomers such as vinyl alcohol and allyl alcohol; amide group-containing monomers such as (meth)acrylamide, N,N-dimethyl (meth)acrylamide, N-methylol (meth)acrylamide, N-methoxymethyl (meth)acrylamide, N-butoxymethyl (meth)acrylamide and N-hydroxyethyl (meth)acrylamide; amino group-containing monomers such as aminoethyl (meth)acrylate, dimethylaminoethyl (meth)acrylate and t-butylaminoethyl (meth)acrylate; epoxy group-containing monomers such as glycidyl (meth)acrylate and methylglycidyl (meth)acrylate; cyano group-containing monomers such as acrylonitrile and methacrylonitrile; heterocyclic ring-containing vinyl monomers such as N-vinyl-2-pyrrolidone, N-vinylcaprolactam, (meth)acryloyl morpholine, N-vinylpyridine, N-vinylpiperidone, N-vinylpyrimidine, N-vinylpiperazine, N-vinylpyrole, N-vinylimidazole and N-vinyloxazole; sulfonic acid group-containing monomers such as sodium vinylsulfonate; phosphoric acid group-containing monomers such as 2-hydroxyethylacryloyl phosphate; imide group-containing monomers such as cyclohexyl maleimide and isopropyl maleimide; and isocyanate group-containing monomers such as 2-methacryloyloxyethyl isocyanate. The hydrophilic monomers may be used each alone or in combinations of two or more thereof.

Among these, as the hydrophilic monomer, the hydroxyl group-containing monomers, the heterocyclic ring-containing vinyl monomers and the amide group-containing monomers are preferable, and the hydroxyl group-containing monomers and the heterocyclic ring-containing vinyl monomers are more preferable. In other words, the hydrophilic monomer is more preferably at least one monomer selected from the group consisting of the hydroxyl group-containing monomers and the heterocyclic ring-containing vinyl monomers.

More specifically, as the hydrophilic monomer, acrylic acid 2-hydroxyethyl ester (2-hydroxyethyl acrylate), acrylic acid 4-hydroxybutyl ester (4-hydroxybutyl acrylate) and N-vinyl-2-pyrrolidone are particularly preferable. In other words, the hydrophilic monomer is particularly preferably at least one monomer selected from the group consisting of acrylic acid 2-hydroxyethyl ester (2-hydroxyethyl acrylate), acrylic acid 4-hydroxybutyl ester (4-hydroxybutyl acrylate) and N-vinyl-2-pyrrolidone.

The content of the hydrophilic monomer in the monomer components constituting the acrylic polymer A is, from the viewpoint of the resistance to clouding caused by humidification, 10% by weight or more, preferably 11% by weight or more and furthermore preferably 12% by weight or more, in relation to the total amount (100% by weight) of the monomer components. The content of the hydrophilic monomer is also 70% by weight or less, preferably 50% by weight or less and more preferably 40% by weight or less. When the monomer components include two or more types of hydrophilic monomers, the aforementioned content of the hydrophilic monomer is the total content of the two or more types of hydrophilic monomers.

With respect to the acrylic polymer A, the monomer components may further include an alkyl (meth)acrylate having a linear or branched alkyl group having 1 to 9 carbon atoms. In present Description, “the alkyl (meth)acrylate having a linear or branched alkyl group having 1 to 9 carbon atoms” is sometimes referred to as “the C₁₋₉ alkyl (meth)acrylate.”

In other words, with respect to the acrylic polymer A, the monomer components may include at least a C₁₀₋₁₆ alkyl (meth)acrylate, a hydrophilic monomer and a C₁₋₉ alkyl (meth)acrylate. The inclusion of the C₁₋₉ alkyl (meth)acrylate preferably allows the pressure-sensitive adhesive layer A to easily avoid becoming too soft.

Specific examples of the C₁₋₉ alkyl (meth)acrylate include: methyl (meth)acrylate, ethyl (meth)acrylate, propyl (meth)acrylate, isopropyl (meth)acrylate, n-butyl (meth) acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate and isononyl (meth)acrylate. The C₁₋₉ alkyl (meth)acrylates may be used each alone or in combinations of two or more thereof.

Among the above-listed C₁₋₉ alkyl (meth)acrylates, as the C₁₋₉ alkyl (meth)acrylate, an alkyl (meth)acrylate having a linear or branched alkyl group having 2 to 9 carbon atoms is preferable. As the C₁₋₉ alkyl (meth)acrylate, an alkyl (meth)acrylate having a branched alkyl group having 1 to 9 (preferably 2 to 9) carbon atoms is preferable. Specifically, 2-ethylhexyl acrylate is particularly preferable.

The content of the C₁₋₉ alkyl (meth)acrylate in the monomer components constituting the acrylic polymer A is not particularly limited, but is preferably 10 to 50% by weight and more preferably 15 to 45% by weight in relation to the total amount (100% by weight) of the monomer components.

With respect to the acrylic polymer A, the monomer components may further include a multifunctional monomer (polyfunctional monomer). The inclusion of the multifunctional monomer allows the gel fraction to be easily regulated through cross-linking. Accordingly, cutting becomes easy and the workability tends to be improved. The multifunctional monomer is not particularly limited; however, examples of the multifunctional monomer include: hexanediol di(meth)acrylate (1,6-hexanediol di(meth)acrylate), butanediol di(meth)acrylate, (poly)ethylene glycol di(meth)acrylate, (poly)propylene glycol di(meth)acrylate, neopentylglycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl (meth)acrylate, vinyl (meth)acrylate, divinylbenzene, epoxy acrylate, polyester acrylate, urethane acrylate. The multifunctional monomers may be used each alone or in combinations of two or more thereof.

Among the above-listed multifunctional monomers, as the multifunctional monomer, 1.6-hexanediol diacrylate and dipentaerythritol hexa(meth)acrylate are preferable.

With respect to the acrylic polymer A, the monomer components may also include, within a range not impairing the advantageous effects of the present invention, a monomer (sometimes referred to as “the other monomer) other than the C₁₀₋₁₆ alkyl (meth)acrylate, the hydrophilic monomer and the C₁₋₉ alkyl (meth)acrylate and the multifunctional monomer. Examples of the other monomer include: alkyl (meth)acrylate having a linear or branched alkyl group having 17 to 24 carbon atoms; aromatic hydrocarbon group-containing (meth)acrylic acid esters such as phenyl (meth)acrylate, phenoxyethyl (meth)acrylate and benzyl (meth)acrylate; alicyclic hydrocarbon group-containing (meth)acrylic acid esters such as cyclohexyl (meth)acrylate, bornyl (meth)acrylate and isobornyl (meth)acrylate; and (meth)acrylic acid esters other than the C₁₀₋₁₆ alkyl (meth)acrylate, the hydrophilic monomer, the C₁₋₉ alkyl (meth)acrylate and the multifunctional monomer such as alkoxyalkyl (meth)acrylates such as methoxyethyl (meth)acrylate and ethoxyethyl (meth)acrylate. Examples of the other monomer also include: vinyl esters such as vinyl acetate and vinyl propionate; aromatic vinyl compounds such as styrene and vinyltoluene; olefins or dienes such as ethylene, butadiene, isoprene and isobutylene; vinyl ethers such as vinyl alkyl ethers; and vinyl chloride. These other monomers may be used each alone or in combinations of two or more thereof.

The acrylic polymer A is obtained by polymerizing the monomer components. More specifically, the acrylic polymer A is obtained by polymerizing, with heretofore known conventional methods, the monomer components, the monomer mixture or the partially polymerized substance thereof. Examples of the polymerization method include: a solution polymerization method, an emulsion polymerization method, a bulk polymerization method and a polymerization method based on heat or active energy ray irradiation (thermal polymerization and active energy ray polymerization). Among these methods, from the viewpoint of transparency, water resistance, cost and others, the solution polymerization method and the active energy ray polymerization method are preferable. For the purpose of suppressing the inhibition of polymerization by oxygen, the polymerization is preferably performed by avoiding the contact with oxygen. For example, the polymerization is preferably performed in a nitrogen atmosphere, or by blocking oxygen with a release film.

Examples of the active energy ray used for irradiation in the active energy ray polymerization (photopolymerization) include: ionizing radiation such as α-ray, β-ray, γ-ray, neutron ray and electron beam; and ultraviolet ray; in particular, ultraviolet ray is preferable. The irradiation energy, irradiation time, irradiation method and the like of the active energy ray are not particularly limited as long as the active energy ray can activate the photopolymerization initiator and allows the reaction of the monomer components to occur.

In the solution polymerization, various common solvents can be used. Examples of such solvents include the following organic solvents: esters such as ethyl acetate and n-butyl acetate; aromatic hydrocarbons such as toluene and benzene; aliphatic hydrocarbons such as n-hexane and n-heptane; alicyclic hydrocarbons such as cyclohexane and methyl cyclohexane; and ketones such as methyl ethyl ketone and methyl isobutyl ketone. These solvents may be used each alone or in combinations of two or more thereof.

In the polymerization, according to the type of the polymerization reaction, a polymerization initiator such as a photopolymerization initiator (photoinitiator) or a thermal polymerization initiator may be used. These polymerization initiators may be used each alone or in combinations of two or more thereof.

The photopolymerization initiator is not particularly limited; however, examples of the photopolymerization initiator include: benzoin ether-based photopolymerization initiators, acetophenone-based photopolymerization initiators, α-ketol-based photopolymerization initiators, aromatic sulfonyl chloride-based photopolymerization initiators, optically active oxime-based photopolymerization initiators, benzoin-based photopolymerization initiators, benzil-based photopolymerization initiators, benzophenone-based photopolymerization initiators, ketal-based photopolymerization initiators and thioxanthone-based photopolymerization initiators.

Examples of the benzoin ether-based photopolymerization initiators include benzoin methyl ether, benzoin ethyl ether, benzoin propyl ether, benzoin isopropyl ether, benzoin isobutyl ether, 2,2-dimethoxy-1,2-diphenylethan-1-one and anisole methyl ether. Examples of the acetophenone-based photopolymerization initiators include 2,2-diethoxyacetophenone, 2,2-dimethoxy-2-phenylacetophenone, 1-hydroxycyclohexyl phenyl ketone, 4-phenoxydichloroacetophenone and 4-(t-butyl)-dichloroacetophenone. Examples of the α-ketol-based photopolymerization initiators include 2-methyl-2-hydroxypropiophenone and 1-[4-(2-hydroxyethyl)-phenyl]-2-hydroxy-2-methylpropan-1-one. Examples of the aromatic sulfonyl chloride-based photopolymerization initiators include 2-naphthalenesulfonyl chloride. Examples of the optically active oxime-based photopolymerization initiators include 1-phenyl-1,1-propanedione-2-(o-ethoxycarbonyl)-oxime. Examples of the benzoin-based photopolymerization initiators include benzoin. Examples of the benzil-based photopolymerization initiator include benzil. Examples of the benzophenone-based photopolymerization initiator include benzophenone, benzoylbenzoic acid, 3,3′-dimethyl-4-methoxybenzophenone, polyvinyl benzophenone and α-hydroxycyclohexyl phenyl ketone. Examples of the ketal-based photopolymerization initiators include benzil methyl ketal. Examples of the thioxanthone-based photopolymerization initiators include thioxanthone, 2-chlorothioxanthone, 2-methylthioxanthone, 2,4-dimethylthioxanthone, isopropylthioxanthone, 2,4-diisopropylthioxanthone and docedylthioxanthone.

The used amount of the photopolymerization initiator is not particularly limited, but is preferably 0.01 to 1 part by weight and more preferably 0.05 to 0.5 part by weight in relation to the total amount (100 parts by weight) of the monomer components.

Examples of the polymerization initiator used in the solution polymerization include azo polymerization initiators, peroxide polymerization initiators (such as dibenzoyl peroxide and tert-butyl permaleate) and redox polymerization initiators. Among these initiators, azo polymerization initiators disclosed in Japanese Patent Application Laid-Open No. 2002-69411 are preferable. Examples of the azo polymerization initiator include 2,2′-azobisisobutyronitrile, 2,2-azobis-2-methylbutyronitrile, dimethyl 2,2′-azobis(2-methylpropionate) and 4,4′-azobis-4-cyanovalerianic acid.

The used amount of the azo polymerization initiator is not particularly limited, but is preferably 0.05 to 0.5 part by weight and more preferably 0.1 to 0.3 part by weight in relation to the total amount (100 parts by weight) of the monomer components.

In the pressure-sensitive adhesive layer A, a silane coupling agent may be included within a range not impairing the advantageous effects of the present invention. In other words, in the pressure-sensitive adhesive composition A, a silane coupling agent may be included if necessary. The inclusion of a silane coupling agent in the pressure-sensitive adhesive layer A preferably improves the adhesion reliability to glass (in particular, adhesion reliability to glass in high temperature-high humidity environment).

The silane coupling agent is not particularly limited; however, examples of the silane coupling agent include γ-glycidoxypropyltrimethoxysilane, γ-glycidoxypropyltriethoxysilane, γ-aminopropyltrimethoxysilane and N-phenyl-aminopropyltrimethoxysilane. Among these silane coupling agents, γ-glycidoxypropyltrimethoxysilane is preferable. Commercially available examples of the silane coupling agent include “KBM-403” (trade name, manufactured by Shin-Etsu Chemical Co., Ltd.). The silane coupling agents may be used each alone or in combinations of two or more thereof.

The content of the silane coupling agent in the pressure-sensitive adhesive layer A is not particularly limited, but is preferably 0.01 to 1 part by weight and more preferably 0.03 to 0.5 part by weight in relation to 100 parts by weight of the acrylic polymer A. For example, the content of the silane coupling agent in the active energy ray curable type pressure-sensitive adhesive composition A including the monomer mixture or the partially polymerized substance of the monomer mixture is not particularly limited, but is preferably 0.01 to 1 part by weight and more preferably 0.03 to 0.5 part by weight in relation to 100 parts by weight of the monomer components constituting the acrylic polymer A.

In the pressure-sensitive adhesive composition A, a cross-linking agent may be further included. The cross-linking agent can cross-link the acrylic polymer A in the pressure-sensitive adhesive layer A, regulate the gel fraction of the pressure-sensitive adhesive layer, and improve the level difference absorbability. The cross-linking agent is not particularly limited; however, examples of the cross-linking agent include isocyanate-based cross-linking agents, epoxy-based cross-linking agents, melamine-based cross-linking agents, peroxide-based cross-linking agents, urea-based cross-linking agents, metal alkoxide-based cross-linking agents, metal chelate-based cross-linking agents, metal salt-based cross-linking agents, carbodiimide-based cross-linking agents, oxazoline-based cross-linking agents, aziridine-based cross-linking agent and amine-based cross-linking agents. Among these cross-linking agents, isocyanate-based cross-linking agents and epoxy-based cross-linking agents are preferable. These cross-linking agents may be used each along or in combinations of two or more thereof.

Examples of the isocyanate-based cross-linking agents (multifunctional isocyanate compounds) include: lower aliphatic polyisocyanates such as 1,2-ethylene diisocyanate, 1,4-butylene diisocyanate and 1,6-hexamethylene diisocyanate; alicyclic polyisocyanates such as cyclopentylene diisocyanate, cyclohexylene diisocyanate, isophorone diisocyanate, hydrogenated tolylenediisocyanate and hydrogenated xylenediisocyanate; aromatic polyisocyanates such as 2,4-tolylenediisocyanate, 2,6-tolylenediisocyanate, 4,4′-diphenylmethanediisocyanate and xylylene diisocyanate. Additional examples of the isocyanate-based cross-linking agents include trimethylolpropane/tolylenediisocyanateadduct (trade name: “Coronate L,” manufactured by Nippon Polyurethane Industry Co., Ltd.) and trimethylolpropane/hexamethylene diisocyanateadduct (trade name: “Coronate HL,” manufactured by Nippon Polyurethane Industry Co., Ltd.).

Examples of the epoxy-based cross-linking agents (multifunctional epoxy compounds) include: N,N,N′,N′-tetraglycidyl-m-xylene diamine, glycidylaniline, 1,3-bis(N,N-glycidylaminomethyl)cyclohexane, 1,6-hexanediol glycidyl ether, neopentylglycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, polyglycerol polyglycidyl ether, sorbitan polyglycidyl ether, trimethylolpropane polyglycidyl ether, adipic acid diglycidyl ester, o-phthalic acid diglycidyl ester, triglycidyl-tris(2-hydroxyethyl) isocyanurate, resorcin diglycidyl ether and bisphenol-S diglycidyl ether; and additionally, epoxy resin having two or more epoxy groups in the molecule thereof. Examples of the epoxy-based cross-linking agents further include a commercially available product “Tetrad C” (trade name, manufactured by Mitsubishi Gas Chemical Company, Inc.).

The content of the cross-linking agent in the pressure-sensitive adhesive layer A is not particularly limited, but is preferably 0.001 to 10 parts by weight and more preferably 0.01 to 3 parts by weight in relation to 100 parts by weight of the monomer components constituting the acrylic polymer A from the viewpoint of controlling the gel fraction of the pressure-sensitive adhesive layer A so as to fall within a preferable range.

In the pressure-sensitive adhesive composition A, a solvent may be included. The solvent is not particularly limited; however, examples of the solvent include the following organic solvents: esters such as ethyl acetate and n-butyl acetate; aromatic hydrocarbons such as toluene and benzene; aliphatic hydrocarbons such as n-hexane and n-heptane; alicyclic hydrocarbons such as cyclohexane and methyl cyclohexane; and ketones such as methyl ethyl ketone and methyl isobutyl ketone. These solvents may be used each alone or in combinations of two or more thereof.

In the pressure-sensitive adhesive layer A, an additive(s) may be included within a range not impairing the advantageous effects of the present invention. In other words, to the pressure-sensitive adhesive composition A, an additive(s) may be added if necessary. Examples of such an additive include: a cross-linking promoter, a tackifier resin (such as a rosin derivative, polyterpene resin, petroleum resin or oil-soluble phenol), an antiaging agent, a filler, a colorant (such as a pigment or a dye), an ultraviolet absorber, an antioxidant, a chain transfer agent, a plasticizer, a softener, a surfactant and an antistatic agent. These additives may be used each alone or in combinations of two or more thereof.

The preparation method of the pressure-sensitive adhesive composition A is not particularly limited; however, examples of the preparation method of the pressure-sensitive adhesive composition A include heretofore known methods. For example, the solvent-type acrylic pressure-sensitive adhesive composition A is prepared by mixing an acrylic polymer, a solvent and components (such as the foregoing silane coupling agent, cross-linking agent, solvent and additive(s)) added if necessary. The active energy ray curable-type acrylic pressure-sensitive adhesive composition is prepared by mixing a monomer mixture or a partially polymerized substance of the monomer mixture and components (such as the foregoing silane coupling agent, cross-linking agent, solvent and additive) added if necessary.

The pressure-sensitive adhesive composition A preferably has a viscosity suitable for handling and coating. Accordingly, the active energy ray curable-type acrylic pressure-sensitive adhesive composition A preferably includes the partially polymerized substance of a monomer mixture. The polymerization percentage of the partially polymerized substance is not particularly limited, but is preferably 5 to 20% by weight and more preferably 5 to 15% by weight.

The polymerization percentage of the partially polymerized substance is derived as follows.

A sample is prepared by sampling a fraction of the partially polymerized substance. The sample is precisely weighed to obtain the weight thereof, and the resulting weight is defined as “the weight of the partially polymerized substance before drying.” Next, the sample is dried at 130° C. for 2 hours, and the sample after drying is precisely weighed to obtain the weight thereof, and the resulting weight is defined as “the weight of the partially polymerized substance after drying.” From “the weight of the partially polymerized substance before drying” and “the weight of the partially polymerized substance after drying,” the weight decrement of the sample due to the drying at 130° C. for 2 hours is derived, and the resulting weight decrement is defined as “the weight decrement” (the weights of the volatilized component and the unreacted monomers).

From the resulting “weight of the partially polymerized substance before drying” and the resulting “weight decrement,” the polymerization percentage of the partially polymerized substance of the monomer components is derived on the basis of the following formula:

polymerization percentage (% by weight) of the partially polymerized substance of the monomer components=[1−(weight decrement)/(weight of partially polymerized substance of monomer components before drying)]×100

The pressure-sensitive adhesive layer A is formed by applying (coating) the pressure-sensitive adhesive composition A to an appropriate support such as a substrate or a release film, and by heat drying and/or curing the applied composition if necessary, although the formation of the pressure-sensitive adhesive layer A is not particularly limited to this. For example, when the pressure-sensitive adhesive layer A is formed with the active energy ray curable-type pressure-sensitive adhesive composition A, the pressure-sensitive adhesive layer A is formed as follows: the pressure-sensitive adhesive composition A is applied (coated) to a support and the applied pressure-sensitive adhesive composition A is irradiated with an active energy ray to form the pressure-sensitive adhesive layer A. If necessary, heat-drying may be performed in addition to the active energy ray irradiation.

In the application (coating), heretofore known coating methods may be used. For example, conventional coaters may be used; specifically, for example, a gravure roll coater, a reverse roll coater, a kiss-roll coater, a dip roll coater, a bar coater, a knife coater, a spray coater, a comma coater or a direct coater may be used.

The gel fraction of the pressure-sensitive adhesive layer A is not particularly limited, but is preferably 40 to 85% by weight, more preferably 45 to 85% by weight and furthermore preferably 50 to 85% by weight. By setting the gel fraction at 85% by weight or less, the cohesive force of the pressure-sensitive adhesive layer A is allowed to be small to some extent, the pressure-sensitive adhesive layer A is allowed to be soft, and hence the pressure-sensitive adhesive layer is allowed to easily follow the level difference portion to improve the level difference absorbability. On the other hand, by setting the gel fraction at 40% by weight or more, it is possible to suppress the occurrence of the problem that the pressure-sensitive adhesive layer becomes too soft, and hence the workability of the pressure-sensitive adhesive sheet is degraded, and it is possible to suppress the occurrence of air bubbles or detachment (lifting) in a high temperature environment or a high temperature-high humidity environment to improve the adhesion reliability. The gel fraction can be controlled by the factors such as the types or contents (used amounts) of the multifunctional monomer and/or the cross-linking agent.

The gel fraction (the proportion of the solvent-insoluble matter) can be derived as the proportion of the ethyl acetate-insoluble matter. Specifically, the gel fraction is derived as the weight fraction (units: % by weight) of the insoluble matter obtained by immersing the pressure-sensitive adhesive layer in ethyl acetate at room temperature (23° C.) for 7 days in relation to the weight of the sample before the immersion. More specifically, the gel fraction as referred to above is the value derived by the following “measurement method of gel fraction.”

(Measurement Method of Gel Fraction)

Approximately 1 g of the pressure-sensitive adhesive layer is sampled and the weight of the sampled pressure-sensitive adhesive layer is measured, and the weight is defined as “the weight of the pressure-sensitive adhesive layer before immersion.” Next, the sampled pressure-sensitive adhesive layer is immersed in 40 g of ethyl acetate for 7 days, then the ethyl acetate-insoluble component (insoluble fraction) is wholly collected, the collected whole insoluble fraction is dried at 130° C. for 2 hours to remove ethyl acetate, the weight of the dried whole insoluble fraction is measured, and the measured weight is defined as “the dry weight of the insoluble fraction” (the weight of the pressure-sensitive adhesive layer after immersion). The gel fraction is derived by substituting the obtained numerical values into the following formula:

gel fraction (% by weight)=[(dry weight of insoluble fraction/weight of pressure-sensitive adhesive layer before immersion)]×100

The shear storage modulus of the pressure-sensitive adhesive layer A at 23° C. is not particularly limited, but is preferably 1.0×10⁵ Pa or less, more preferably 9.5×10⁴ Pa or less and furthermore preferably 9.0×10⁴ Pa or less, from the viewpoint of improving the level difference absorbability. The lower limit of the shear storage modulus of the pressure-sensitive adhesive layer A at 23° C. is not particularly limited, but is preferably 1.0×10⁴ Pa, more preferably 1.5×10⁴ Pa and furthermore preferably 2.0×10⁴ Pa.

The shear storage modulus is the shear storage modulus at 23° C. measured by the dynamic viscoelastic measurement. For example, the pressure-sensitive adhesive layer is laminated in a plurality of layers so as to have a thickness of approximately 1.5 mm, and the shear storage modulus can be measured by using a dynamic viscoelasticity measurement apparatus (model: “ARES,” manufactured by TA Instruments Inc.) in a shear mode, under a frequency condition of 1 Hz, in a range from −70 to 200° C. at a temperature increase rate of 5° C./min.

The melting point of the pressure-sensitive adhesive layer A is not particularly limited, but is preferably −60 to 20° C., more preferably −40 to 10° C. and furthermore preferably −30 to 0° C. When the melting point is higher than 20° C., the pressure-sensitive adhesive force cannot be developed at room temperature.

The melting point can be measured by using the pressure-sensitive adhesive layer as the measurement sample, with a differential scanning calorimetric (DSC) measurement, in conformity with JIS K 7121, without being particularly limited to this way of measurement. Specifically, the melting point can be measured by using a measurement apparatus, model “Q-2000” manufactured by TA instruments Inc. under the condition of the temperature increase rate of 10° C./min in a range from −80° C. to 80° C.

The thickness of the pressure-sensitive adhesive layer A is not particularly limited, but is preferably 10 μm to 1 mm, more preferably 100 to 500 μm and furthermore preferably 150 to 350 μm. By setting the thickness at 10 μm or more, the pressure-sensitive adhesive layer is allowed to easily follow the level difference portion and thus level difference absorbability is improved. By setting the thickness at 1 mm or less, the pressure-sensitive adhesive layer is allowed to be hardly deformed and thus the workability is improved.

(Substrate (Base Material))

The pressure-sensitive adhesive sheet of the present invention may be a pressure-sensitive adhesive sheet with a substrate. Examples of such a substrate include various optical films such as a plastic film, an antireflection (AR) film, a polarizing plate and a retardation film. Examples of the materials for the plastic film and the like include the following plastic materials: polyester resins such as polyethylene terephthalate (PET); acrylic resins such as polymethylmethacrylate (PMMA); polycarbonate; triacetylcellulose (TAC); polysulfone; polyarylate; polyimide; polyvinyl chloride; polyvinyl acetate; polyethylene; polypropylene; ethylene-propylene copolymer; and cyclic olefin polymers such as “Arton” (trade name, cyclic olefin polymer, manufactured by JSR Corp.) and “Zeonoa” (trade name, cyclic olefin polymer, manufactured by Zeon Corp.). These plastic materials may be used each alone or in combinations of two or more thereof. The “substrate” as referred to above means the part attached to the adherend together with the pressure-sensitive adhesive layer when the pressure-sensitive adhesive sheet is attached to an adherend (such as an optical component). The release film (separator) to be released when the pressure-sensitive adhesive sheet is used (attached) is not included in the “substrate.”

The substrate is preferably transparent. The total light transmittance (in conformity with JIS K7361-1) of the substrate in the visible light wavelength region is not particularly limited, but is preferably 85% or more and more preferably 88% or more. The haze (in conformity with JIS K7136) of the substrate is not particularly limited, but is preferably 1.5% or less and more preferably 1.0% or less. Examples of such a transparent substrate include PET film, and non-oriented films such as “Arton” (trade name) and “Zeonoa” (trade name).

The thickness of the substrate is not particularly limited, but is preferably 12 to 75 μm. The substrate may have either a single layered form or a double-layered form. The surface of the substrate may be appropriately subjected to a heretofore known conventional surface treatment such as a physical treatment such as corona discharge treatment or plasma treatment, or a chemical treatment such as primer coating treatment.

(Another Pressure-Sensitive Adhesive Layer)

The pressure-sensitive adhesive sheet of the present invention may include another pressure-sensitive adhesive layer (a pressure-sensitive adhesive layer other than the pressure-sensitive adhesive layer A). The another pressure-sensitive adhesive layer is not particularly limited; however, examples of the another pressure-sensitive adhesive layer include: pressure-sensitive adhesive layers formed of heretofore known or conventional pressure-sensitive adhesives such as urethane-based pressure-sensitive adhesives, acrylic pressure-sensitive adhesives, rubber-based pressure-sensitive adhesives, silicone-based pressure-sensitive adhesives, polyester-based pressure-sensitive adhesives, polyamide-based pressure-sensitive adhesives, epoxy-based pressure-sensitive adhesives, vinyl alkyl ether-based pressure-sensitive adhesives and fluorine-based pressure-sensitive adhesives. These pressure-sensitive adhesives may be used each alone or in combinations of two or more thereof.

(Other Layers)

The pressure-sensitive adhesive sheet of the present invention may include other layers (such as an intermediate layer and a primer layer) in addition to the pressure-sensitive adhesive layer A, another pressure-sensitive adhesive layer(s) and the substrate.

(Release Film)

The pressure-sensitive adhesive sheet of the present invention may have a release film(s) (separator(s)) as disposed on the pressure-sensitive surface(s) until the pressure-sensitive adhesive sheet is used. The form of protecting the pressure-sensitive adhesive surface(s) of the pressure-sensitive adhesive sheet of the present invention is not particularly limited; for example, either of the following two forms may be adopted: one is the form of protecting the pressure-sensitive sides respectively with two release films, and the other is the form of protecting both pressure-sensitive sides with one release film, both sides of which are release surfaces, by winding the release film in a roll shape. The release film is used as a protecting material of the pressure-sensitive adhesive layer, and is peeled off when the pressure-sensitive adhesive sheet is attached to an adherend. In the pressure-sensitive adhesive sheet of the present invention, the release film also undertakes a role of a support of the pressure-sensitive adhesive layer. The release film is not necessarily required to be disposed.

The release film is not particularly limited; however, examples of the release film include a substrate having a release-treated layer, a low adhesive substrate made of a fluoropolymer and a low adhesive substrate made of a nonpolar polymer. Examples of the substrate having a release-treated layer include a plastic film, paper or the like the surface of which is treated with a release treatment agent such as a silicone-based, a long-chain alkyl-based or a fluorine-based release treatment agent, or molybdenum sulfide. Examples of the fluorine-based polymer in the low adhesive substrate made of a fluoropolymer include polytetrafluoroethylene, polychlorotrifluoroethylene, polyvinyl fluoride, polyvinylidene fluoride, tetrafluoroethylene-hexafluoropropylene copolymer and chlorofluoroethylene-vinylidene fluoride copolymer. Examples of the nonpolar polymer include olefin resins (such as polyethylene and polypropylene). The separator is formed by a heretofore known or conventional method. The thickness and the like of the separator are also not particularly limited.

Examples of the production method of the pressure-sensitive adhesive sheet of the present invention include heretofore known or conventional production methods. The production method of the pressure-sensitive adhesive sheet of the present invention is varied depending on the factors such as the composition of the pressure-sensitive adhesive composition A, and is not particularly limited; however, examples of the production method of the pressure-sensitive adhesive sheet of the present invention include the following methods (1) to (3).

(1) The pressure-sensitive adhesive composition A including the partially polymerized substance of the monomer components, and if necessary, a polymerization initiator, a silane coupling agent, other additives and the like is applied (coated) to a substrate or a separator, and is cured (for example, heat cured or cured with an active energy ray such as ultraviolet ray) to produce the pressure-sensitive adhesive sheet.

(2) A pressure-sensitive adhesive composition (solution) prepared by dissolving the acrylic polymer, and if necessary, additives and the like is applied (coated) to a substrate or a separator, and is dried and/or cured to produce the pressure-sensitive adhesive sheet.

(3) The pressure-sensitive adhesive sheet of the present invention produced in the foregoing (1) is further dried.

When the curing with an active energy ray (photocuring) is utilized, because the photopolymerization reaction is inhibited by the oxygen in the air, it is preferable to block the oxygen, for example, by laminating a separator, or by photocuring in a nitrogen atmosphere.

The pressure-sensitive adhesive sheet of the present invention is not particularly limited, but is preferably, from a view point of productivity, a pressure-sensitive adhesive sheet produced with a pressure-sensitive adhesive composition including the partially polymerized substance of the monomer components and a polymerization initiator (a polymerization initiator such as a photopolymerization initiator or a thermal polymerization initiator) by utilizing the curing reaction based on heat or an active energy ray. The pressure-sensitive adhesive sheet of the present invention is preferably produced with a pressure-sensitive adhesive composition including a photopolymerization initiator, by utilizing the curing reaction based on an active energy ray, from the viewpoints of easiness in obtaining a pressure-sensitive adhesive layer having a certain thickness.

The thickness (total thickness) of the pressure-sensitive adhesive sheet of the present invention is not particularly limited, but is preferably 10 μm to 1 mm, more preferably 100 to 500 μm and furthermore preferably 150 to 350 μm. By setting the thickness at 10 μm or more, the pressure-sensitive adhesive layer is allowed to easily follow the level difference portion and the improvement of the level difference absorbability can be achieved. The thickness of the pressure-sensitive adhesive sheet of the present invention does not include the thickness of the release film.

The pressure-sensitive adhesive sheet of the present invention preferably has a high transparency. The haze (in conformity with JIS K 7136) of the pressure-sensitive adhesive sheet of the present invention is preferably, for example, 1.0% or less and more preferably 0.7% or less. By setting the haze at 1.0% or less, optical products or optical components on which the pressure-sensitive adhesive sheet is attached are allowed to acquire satisfactory transparency and exterior appearance.

The total light transmittance (the total light transmittance in the visible light wavelength region) (in conformity with JIS K 7361-1) of the pressure-sensitive. adhesive sheet of the present invention is not particularly limited, but is preferably 90% or more and more preferably 91% or more. By setting the total light transmittance at 90% or more, optical products or optical components on which the pressure-sensitive adhesive sheet is attached are allowed to acquire satisfactory transparency and exterior appearance.

The haze and the total light transmittance can be measured by laminating a glass plate or the like on the pressure-sensitive adhesive sheet and by using a haze meter.

Accordingly, from the viewpoint of the improvement of the optical properties such as transparency, the pressure-sensitive adhesive sheet of the present invention is preferably a pressure-sensitive adhesive sheet in which the haze is preferably 1.0% or less and the total light transmittance is 90% or more. From the viewpoint of the improvement of the optical properties such as transparency, the use in laminating adherends on each other or the like, the pressure-sensitive adhesive sheet of the present invention is preferably a double-sided pressure-sensitive adhesive sheet in which the haze is preferably 1.0% or less and the total light transmittance is 90% or more, and is particularly preferably a substrate-less double-sided pressure-sensitive adhesive sheet which has only the pressure-sensitive adhesive layer A and in which the haze is preferably 1.0% or less and the total light transmittance is 90% or more.

The pressure-sensitive adhesive sheet of the present invention includes the pressure-sensitive adhesive layer A, and hence is excellent in the resistance to clouding caused by humidification.

The pressure-sensitive adhesive sheet of the present invention includes the pressure-sensitive adhesive layer A, and hence is excellent in the level difference absorbability. For example, the pressure-sensitive adhesive sheet of the present invention is excellent in the level difference absorbability even for a level difference as high as exceeding 40 μm as well as for the level difference of 5 to 10 μm. Additionally, the pressure-sensitive adhesive sheet of the present invention has a level difference absorbability for a level difference as high as exceeding 80 μm.

Additionally, the pressure-sensitive adhesive sheet of the present invention include the pressure-sensitive adhesive layer A, and hence is excellent in the adhesion reliability.

The pressure-sensitive adhesive sheet of the present invention is not particularly limited to the following applications, but is suitably used in optical applications, bond applications, protection applications and the like. Among such applications, the pressure-sensitive adhesive sheet of the present invention is particularly suitable for optical applications. More specifically, for example, such applications involve optical pressure-sensitive adhesive sheets used in the applications for laminating optical components (for use in laminating optical components) and the applications for production of products (optical products) using optical components.

The optical components are not particularly limited as long as the components have optical properties (such as optical polarization property, optical refraction property, optical scattering property, optical reflection property, optical transmission property, optical absorption property, optical diffraction property, optical rotation property and visibility); however, examples of the optical components include: components constituting optical products such as display devices (image display devices) and input devices or components used in these apparatuses (optical products); more specifically, examples of the optical components include: a polarizing plate, a wave plate, a retardation plate, an optical compensation film, a brightness-improving film, a light guide plate, a reflection film, an antireflection film, a transparent conductive film (such as ITO film), a design film, a decorative film, a surface protection plate, a prism, a lens, a color filter, a transparent substrate, and, in addition, components obtained by laminating these components.

Examples of the display device (image display device) include a liquid crystal display device, an organic EL (electroluminescence) display device, a PDP (plasma display panel) and an electronic paper. Examples of the input device include a touch panel.

The optical components are not particularly limited; however, examples of the optical component include components (such as sheet-shaped, film-shaped or plate-shaped components) made of glass, acrylic resin, polycarbonate, polyethylene terephthalate or metal thin film. The “optical components” are construed to also include the components (such as design films, decoration films and surface protection plates) undertaking, as described above, the role of decoration and protection while maintaining the visibility of display devices and input devices, which are adherends.

The pressure-sensitive adhesive sheet of the present invention is preferably used, above all for laminating highly rigid optical components, in particular, for laminating optical components made of glass. Specifically, the pressure-sensitive adhesive sheet of the present invention is preferably an optical pressure-sensitive adhesive sheet used in applications for laminating optical components made of glass such as glass sensors, glass display panels (such as LCDs) and glass plates with transparent electrodes of touch panels, and more preferably an optical pressure-sensitive adhesive sheet used in applications for laminating glass sensors and display panels.

The form of laminating optical components with the pressure-sensitive adhesive sheet of the present invention is not particularly limited; however, examples of such forms include the following:

(1) A form in which optical components are laminated on each other through the intermediary of the pressure-sensitive adhesive sheet of the present invention.

(2) A form in which optical components are laminated on components other than optical components through the intermediary of the pressure-sensitive adhesive sheet of the present invention.

(3) A form in which the pressure-sensitive adhesive sheet of the present invention including optical components is laminated on optical components or components other than optical components.

The pressure-sensitive adhesive sheet of the present invention including optical components in the foregoing form (3) is preferably a pressure-sensitive adhesive sheet with a substrate including an optical component as the substrate, namely, a pressure-sensitive adhesive sheet with an optical component.

The pressure-sensitive adhesive sheet with an optical component is also a pressure-sensitive adhesion-type optical component including the pressure-sensitive adhesive layer A on the optical component.

### EXAMPLES

Hereinafter, the present invention is described in more detail with reference to Examples; however, the present invention is not limited by these Examples.

### Example 1

A mixture (monomer mixture) was obtained by mixing 50 parts by weight of lauryl acrylate (LA), 32 parts by weight of 2-ethylhexyl acrylate (2EHA), 8 parts by weight of 4-hydroxybutyl acrylate (HBA) and 10 parts by weight of N-vinyl-2-pyrrolidone (NVP).

Next, in a four-neck flask, 100 parts by weight of the foregoing mixture, 0.05 part by weight of 1-hydroxy-cyclohexyl-phenyl-ketone (trade name:“Irgacure 184,” manufactured by BASF Japan Ltd., photopolymerization initiator) and 0.05 part by weight of 2,2-dimethoxy-1,2-diphenylethan-1-one (trade name:“Irgacure 651,” manufactured by BASF Japan Ltd., photopolymerization initiator) were placed; the resulting mixture was irradiated with ultraviolet ray to be photopolymerized in a nitrogen atmosphere, until the viscosity of the mixture reached approximately 15 Pa·s (BH viscometer, No. 5 rotor, 10 rpm, temperature: 30° C.), and thus a partially polymerized monomer syrup (a partially polymerized substance of the monomer components) was obtained.

With 100 parts by weight of the partially polymerized monomer syrup, 0.04 part by weight of 1.6-hexanediol diacrylate (HDDA, multifunctional monomer), 0.05 part by weight of 1-hydroxy-cyclohexyl-phenyl-ketone (trade name: “Irgacure 184,” manufactured by BASF Japan Ltd., photopolymerization initiator (additional initiator)), 0.05 part by weight of 2,2-dimethoxy-1,2-diphenylethan-1-one (trade name: “Irgacure 651,” manufactured by BASF Japan Ltd., photopolymerization initiator (additional initiator)) and 0.3 part by weight of a silane coupling agent (trade name: “KBM-403,” manufactured by Shin-Etsu Chemical Co., Ltd.) were uniformly mixed to yield a pressure-sensitive adhesive composition.

The pressure-sensitive adhesive composition was applied to the release-treated surface of a release film (trade name: “ MRF#38,” manufactured by Mitsubishi Plastics, Inc.) so as for the thickness after the formation of the pressure-sensitive adhesive layer to be 175 thus a pressure-sensitive adhesive composition layer was formed, and then a release film (trade name: “MRN#38,” manufactured by Mitsubishi Plastics, Inc.) was laminated on the surface of the pressure-sensitive adhesive composition layer. Then, the pressure-sensitive adhesive composition layer was irradiated with ultraviolet ray under the conditions of the illuminance: 4 mW/cm² and the light intensity: 1200 mJ/cm², and thus the pressure-sensitive adhesive composition layer was photocured to form a pressure-sensitive adhesive layer. Then, a pressure-sensitive adhesive sheet (substrate-less double-sided pressure-sensitive adhesive sheet) in which both sides of the pressure-sensitive adhesive layer were each protected with a release films was obtained.

### Examples 2

A mixture (monomer mixture) was obtained by mixing 60 parts by weight of lauryl acrylate (LA), 22 parts by weight of 2-ethylhexyl acrylate (2EHA), 8 parts by weight of 4-hydroxybutyl acrylate (HBA) and 10 parts by weight of N-vinyl-2-pyrrolidone (NVP).

Next, a pressure-sensitive adhesive composition was obtained in the same manner as in Example 1.

Then, a pressure-sensitive adhesive sheet in which both sides of the pressure-sensitive adhesive layer were each protected with a release film was obtained in the same manner as in Example 1.

### Example 3

A mixture (monomer mixture) was obtained by mixing 70 parts by weight of lauryl acrylate (LA), 18 parts by weight of 2-ethylhexyl acrylate (2EHA), 6 parts by weight of 2-hydroxyethyl acrylate (HEA) and 6 parts by weight of N-vinyl-2-pyrrolidone (NVP).

Next, a pressure-sensitive adhesive composition was obtained in the same manner as in Example 1.

Then, a pressure-sensitive adhesive sheet in which both sides of the pressure-sensitive adhesive layer were each protected with a release film was obtained in the same manner as in Example 1.

### Example 4

A mixture (monomer mixture) was obtained by mixing 90 parts by weight of lauryl acrylate (LA), 6 parts by weight of 2-hydroxyethyl acrylate (HEA) and 4 parts by weight of N-vinyl-2-pyrrolidone (NVP).

Next, a pressure-sensitive adhesive composition was obtained in the same manner as in Example 1.

Then, a pressure-sensitive adhesive sheet in which both sides of the pressure-sensitive adhesive layer were each protected with a release film was obtained in the same manner as in Example 1.

### Example 5

A mixture (monomer mixture) was obtained by mixing 40 parts by weight of lauryl acrylate (LA), 42 parts by weight of 2-ethylhexyl acrylate (2EHA), 8 parts by weight of 4-hydroxybutyl acrylate (HBA) and 10 parts by weight of N-vinyl-2-pyrrolidone (NVP).

Next, a pressure-sensitive adhesive composition was obtained in the same manner as in Example 1.

Then, a pressure-sensitive adhesive sheet in which both sides of the pressure-sensitive adhesive layer were each protected with a release film was obtained in the same manner as in Example 1.

### Comparative Example 1

A mixture (monomer mixture) was obtained by mixing 22 parts by weight of lauryl acrylate (LA), 60 parts by weight of 2-ethylhexyl acrylate (2EHA), 8 parts by weight of 4-hydroxybutyl acrylate (HBA) and 10 parts by weight of N-vinyl-2-pyrrolidone (NVP).

Next, a pressure-sensitive adhesive composition was obtained in the same manner as in Example 1.

Then, a pressure-sensitive adhesive sheet in which both sides of the pressure-sensitive adhesive layer were each protected with a release film was obtained in the same manner as in Example 1.

### Comparative Example 2

A mixture (monomer mixture) was obtained by mixing 84 parts by weight of lauryl acrylate (LA), 10 parts by weight of isobornyl acrylate (IBXA) and 6 parts by weight of N-vinyl-2-pyrrolidone (NVP).

Next, a pressure-sensitive adhesive composition was obtained in the same manner as in Example 1.

Then, a pressure-sensitive adhesive sheet in which both sides of the pressure-sensitive adhesive layer were each protected with a release film was obtained in the same manner as in Example 1.

### Comparative Example 3

A mixture (monomer mixture) was obtained by mixing 85 parts by weight of 2-ethylhexyl acrylate (2EHA), 5 parts by weight of isobornyl acrylate (IBXA) and 10 parts by weight of 2-hydroxyethyl acrylate (HEA).

Next, a pressure-sensitive adhesive composition was obtained in the same manner as in Example 1.

Then, a pressure-sensitive adhesive sheet in which both sides of the pressure-sensitive adhesive layer were each protected with a release film was obtained in the same manner as in Example 1.

### Comparative Example 4

A mixture (monomer mixture) was obtained by mixing 68 parts by weight of 2-ethylhexyl acrylate (2EHA), 19 parts by weight of 2-hydroxyethyl acrylate (HEA) and 12 parts by weight of N-vinyl-2-pyrrolidone (NVP).

Next, a pressure-sensitive adhesive composition was obtained in the same manner as in Example 1.

Then, a pressure-sensitive adhesive sheet in which both sides of the pressure-sensitive adhesive layer were each protected with a release film was obtained in the same manner as in Example 1.

(Evaluations)

For the pressure-sensitive adhesive sheet obtained in each of Examples and Comparative Examples, the gel fraction, shear storage modulus at 23° C., haze, total light transmittance, level difference absorbability and resistance to clouding caused by humidification were measured or evaluated. The measurement methods or the evaluation methods are presented below. The measurement results and the evaluation results are shown in Table 1.

(1) Gel Fraction

The measurement of the gel fraction was performed according to foregoing “Measurement Method of Gel Fraction.”

(2) Shear Storage Modulus at 23° C. [Shear Storage Modulus (23° C.)]

The shear storage modulus at 23° C. was obtained by the dynamic viscoelastic measurement.

The pressure-sensitive adhesive sheet was laminated to obtain an approximately 1.5-mm thick laminate (laminated pressure-sensitive adhesive layer). The laminate was used as a measurement sample.

The measurement sample was measured by using a dynamic viscoelastic measurement apparatus (model: “ARES,” manufactured by TA Instruments Inc.) under a frequency condition of 1 Hz, in a range from −70 to 200° C. at a temperature increase rate of 5° C./min, and the shear storage modulus at 23° C. was derived.

(3) Total Light Transmittance and Haze

One release film was peeled from a pressure-sensitive adhesive sheet, and the pressure-sensitive adhesive sheet was laminated on a glass plate (stock number “S111,” slide glass, manufactured by Matsunami Glass Ind., Ltd., thickness: 1.0 mm, haze: 0.1%). Then, the other release film was peeled to prepare a specimen.

For the specimen, by using a haze meter (model: “HM-150,” manufactured by Murakami Color Research Laboratory Co., Ltd.), the total light transmittance (%) was measured in conformity with JIS K 7361-1 and the haze (%) was measured in conformity with JIS K 7136.

(4) Level Difference Absorbability (Height of the Level Difference: 42 μm)

A sheet piece of 50 mm in width and 100 mm in length was cut out from a pressure-sensitive adhesive sheet.

From the sheet piece, one release film was peeled, and the sheet piece was laminated by using a hand roller on a glass plate (a cut piece of soda-lime glass plate, manufactured by Matsunami Glass Ind., Ltd., 100 mm in length, 50 mm in width, and 0.7 mm in thickness).

Next, from the sheet piece laminated on the glass plate, the other release film was peeled, and then, a glass plate with a printing level difference was laminated on the sheet piece so as for the side provided with the printing level difference and the pressure-sensitive adhesive side to be brought into contact with each other under the following lamination conditions. Thus, an evaluation sample having a configuration of glass plate/pressure-sensitive adhesive sheet/glass plate with printing level difference was obtained.

(Lamination Conditions)

Surface pressure: 0.3 MPa

Degree of vacuum: 30 Pa

Attaching time: 17 seconds

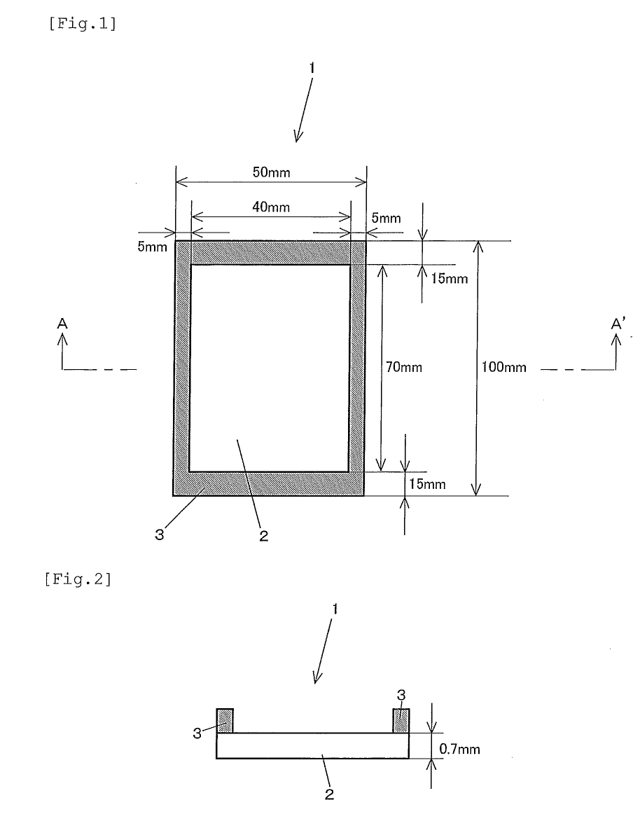

The glass plate with the printing level difference was a glass plate obtained by performing printing with a printed portion thickness (the height of the printing level difference) of 42 μm, on one side of a glass plate (100 mm in length, 50 mm in width, 0.7 mm in thickness, manufactured by Matsunami Glass Ind., Ltd.). Schematic views of the glass plate with the printing level difference are shown in FIGS. 1 and 2.

Next, the evaluation sample was placed in an autoclave, and subjected to an autoclave treatment for 15 minutes under the conditions of a pressure set at 5 atm and a temperature set at 50° C.

After the autoclave treatment, the evaluation sample was taken out, the attaching condition between the pressure-sensitive adhesive layer and the glass plate with the printing level difference was visually observed, and the level difference absorbability was evaluated on the basis of the following evaluation standards.

Evaluation Standards

Good: Remaining air bubbles are not found, and no detachment (lifting) occurs between the pressure-sensitive adhesive sheet and the glass plate with the printing level difference.

Poor: Remaining air bubbles are found and detachment (lifting) occurs between the pressure-sensitive adhesive sheet and the glass plate with the printing level difference.

(5) Resistance to Clouding Caused by Humidification

A sheet piece of 50 mm in width and 100 mm in length was cut out from a pressure-sensitive adhesive sheet.

From the sheet piece, one release film was peeled, and the sheet piece was laminated by using a hand roller on a glass plate (a cut piece of soda-lime glass plate, manufactured by Matsunami Glass Ind., Ltd., 100 mm in length, 50 mm in width, and 0.7 mm in thickness).

Next, from the sheet piece laminated on the glass plate, the other release film was peeled, and then, a glass plate (a cut piece of soda-lime glass plate, manufactured by Matsunami Glass Ind., Ltd., 100 mm in length, 50 mm in width, and 0.7 mm in thickness) was laminated on the sheet piece under the following lamination conditions. Thus, an evaluation sample having a configuration of glass plate/pressure-sensitive adhesive sheet/glass plate was obtained.

(Lamination Conditions)

Surface pressure: 0.3 MPa

Degree of vacuum: 30 Pa

Attaching time: 17 seconds

Next, the evaluation sample was placed in an autoclave, and subjected to an autoclave treatment for 15 minutes under the conditions of a pressure set at 5 atm and a temperature set at 50° C.

After the autoclave treatment, the evaluation sample was taken out, and the taken-out evaluation sample was allowed to stand in a high temperature-high humidity environment (in an environment of a temperature set at 60° C. and a humidity set at 95%) for 300 hours.

Then, the evaluation sample was taken out from the high temperature-high humidity environment, and the taken-out sample was allowed to stand in a normal-state environment (temperature: 23° C., humidity: 50%).

After being allowed to stand in the normal-state environment for 1 hour, the exterior appearance of the evaluation sample was visually observed, and the resistance to clouding caused by humidification was evaluated on the basis of the following evaluation standards.

Evaluation Standards

5: No clouding occurs.

4: Clouding occurs at the four corners.

3: Clouding occurs at the four corners and in a portion of the periphery.

2: Clouding occurs on the whole periphery.

1: Clouding occurs over the whole evaluation sample.

When the evaluation mark based on the foregoing evaluation standards is 4 or 5, the evaluation sample can be evaluated to be excellent in the resistance to clouding caused by humidification, and when the evaluation mark is 1, 2 or 3, the evaluation sample can be evaluated to be poor in the resistance to clouding caused by humidification.

TABLE 1

| | | | | | | | | | | | | | Level | |
|---|---|---|---|---|---|---|---|---|---|---|---|---|---|---|
| | | | | | | | | | | | | | difference | Resistance |
| | | | | | | | | | | Shear | Total | | absorbability | to |
| | Pressure-sensitive adhesive composition | | | | | | | Gel | | storage | light | | (Level | clouding |
| | Mixing parts of monomer | | | | | | KBM-403 | fraction | | modulus at | transmit- | | difference | caused by |
| | components [parts by weight] | | | | | | [parts by | [% by | Thickness | 23° C. | tance | Haze | height: 42 | humidi- |
| | LA | 2EHA | IBXA | HBA | HEA | NVP | weight] | weight] | [μm] | [Pa] | [%] | [%] | μm] | fication |
| Example 1 | 50 | 32 | — | 8 | — | 10 | 0.3 | 60 | 175 | 7.5 × 10⁴ | 92.3 | 0.4 | Good | 5 |
| Example 2 | 60 | 22 | — | 8 | — | 10 | 0.3 | 67 | 175 | 4.8 × 10⁴ | 92.3 | 0.4 | Good | 5 |
| Example 3 | 70 | 18 | — | — | 6 | 6 | 0.3 | 72 | 175 | 3.5 × 10⁴ | 92.3 | 0.4 | Good | 5 |
| Example 4 | 90 | — | — | — | 6 | 4 | 0.3 | 81 | 175 | 3.1 × 10⁴ | 92.3 | 0.4 | Good | 5 |
| Example 5 | 40 | 42 | — | 8 | — | 10 | 0.3 | 63 | 175 | 8.8 × 10⁴ | 92.3 | 0.4 | Good | 4 |
| Comparative | 22 | 60 | — | 8 | — | 10 | 0.3 | 65 | 175 | 1.1 × 10⁵ | 92.3 | 0.4 | Poor | 3 |
| Example 1 | | | | | | | | | | | | | | |
| Comparative | 84 | — | 10 | — | — | 6 | 0.3 | 66 | 175 | 3.7 × 10⁴ | 92.3 | 0.4 | Good | 2 |
| Example 2 | | | | | | | | | | | | | | |
| Comparative | — | 85 | 5 | — | 10 | — | 0.3 | 60 | 175 | 1.2 × 10⁵ | 92.3 | 0.4 | Good | 3 |
| Example 3 | | | | | | | | | | | | | | |
| Comparative | — | 68 | — | — | 19 | 12 | 0.3 | 80 | 175 | 1.98 × 10⁵ | 92.3 | 0.4 | Poor | 5 |
| Example 4 | | | | | | | | | | | | | | |

The abbreviations used in Table 1 are as follows:
LA: Lauryl acrylate
2EHA: 2-Ethylhexyl acrylate
IBXA: Isobornyl acrylate
HBA: 4-Hydroxybutyl acrylate
HEA: 2-Hydroxyethyl acrylate
NVP: N-vinyl-2-pyrrolidone
KBM-403: Silane coupling agent (trade name: “KBM-403,” manufactured by Shin-Etsu Chemical Co., Ltd.)

### REFERENCE SIGNS LIST

1 Glass plate with printing level difference
2 Glass plate
3 Printed portion

1. A pressure-sensitive adhesive sheet including a pressure-sensitive adhesive layer,
wherein the pressure-sensitive adhesive layer includes an acrylic polymer obtained by polymerizing monomer components;
the monomer components include an alkyl (meth)acrylate having a linear or branched alkyl group having 10 to 16 carbon atoms and a hydrophilic monomer,
the content of the alkyl (meth)acrylate is 30% by weight or more in relation to the total amount (100% by weight) of the monomer components; and
the content of the hydrophilic monomer is 10% by weight or more in relation to the total amount (100% by weight) of the monomer components.

2. The pressure-sensitive adhesive layer according to claim 1, wherein the content of the acrylic polymer is 50% by weight or more.

3. The pressure-sensitive adhesive sheet according to claim 1, wherein the gel fraction of the pressure-sensitive adhesive layer is 40 to 85% by weight and the shear storage modulus at 23° C. of the pressure-sensitive adhesive layer is 1.0×10⁵ Pa.

4. The pressure-sensitive adhesive sheet according to claim 1, wherein the hydrophilic monomer is a monomer selected form the group consisting of a hydroxyl group-containing monomer and a heterocyclic ring-containing vinyl monomer.

5. The pressure-sensitive adhesive sheet according to claim 1, wherein the haze thereof is 1.0% or less and the total light transmittance thereof is 90% or more.

6. The pressure-sensitive adhesive sheet according to claim 1, comprising only the pressure-sensitive adhesive layer.

7. The pressure-sensitive adhesive sheet according to claim 2, wherein the gel fraction of the pressure-sensitive adhesive layer is 40 to 85% by weight and the shear storage modulus at 23° C. of the pressure-sensitive adhesive layer is 1.0×10⁵ Pa.

8. The pressure-sensitive adhesive sheet according to claim 2, wherein the hydrophilic monomer is a monomer selected form the group consisting of a hydroxyl group-containing monomer and a heterocyclic ring-containing vinyl monomer.

9. The pressure-sensitive adhesive sheet according to claim 3, wherein the hydrophilic monomer is a monomer selected form the group consisting of a hydroxyl group-containing monomer and a heterocyclic ring-containing vinyl monomer.

10. The pressure-sensitive adhesive sheet according to claim 7, wherein the hydrophilic monomer is a monomer selected form the group consisting of a hydroxyl group-containing monomer and a heterocyclic ring-containing vinyl monomer.

11. The pressure-sensitive adhesive sheet according to claim 2, wherein the haze thereof is 1.0% or less and the total light transmittance thereof is 90% or more.

12. The pressure-sensitive adhesive sheet according to claim 3, wherein the haze thereof is 1.0% or less and the total light transmittance thereof is 90% or more.

13. The pressure-sensitive adhesive sheet according to claim 4, wherein the haze thereof is 1.0% or less and the total light transmittance thereof is 90% or more.

14. The pressure-sensitive adhesive sheet according to claim 7, wherein the haze thereof is 1.0% or less and the total light transmittance thereof is 90% or more.

15. The pressure-sensitive adhesive sheet according to claim 8, wherein the haze thereof is 1.0% or less and the total light transmittance thereof is 90% or more.

16. The pressure-sensitive adhesive sheet according to claim 9, wherein the haze thereof is 1.0% or less and the total light transmittance thereof is 90% or more.

17. The pressure-sensitive adhesive sheet according to claim 2, comprising only the pressure-sensitive adhesive layer.

18. The pressure-sensitive adhesive sheet according to claim 3, comprising only the pressure-sensitive adhesive layer.

19. The pressure-sensitive adhesive sheet according to claim 4, comprising only the pressure-sensitive adhesive layer.

20. The pressure-sensitive adhesive sheet according to claim 5, comprising only the pressure-sensitive adhesive layer.
